(19) United States
(12) Patent Application Publication
(10) Pub. No.: US 2024/0123534 A1
(43) Pub. Date: Apr. 18, 2024

(54) MOBILE SYSTEM FOR CUTTING AND WELDING APPLICATIONS

(71) Applicant: Vectis Automation, LLC, Loveland, CO (US)

(72) Inventors: Andrew Akey, Windsor, CO (US); Joshua Pawley, Windsor, CO (US); Douglas Rhoda, Fort Collins, CO (US); Alex Roerty, Berthoud, CO (US); Todd Scarpella, Fort Collins, CO (US)

(73) Assignee: Vectis Automation, LLC, Loveland, CO (US)

(21) Appl. No.: 18/465,112

(22) Filed: Sep. 11, 2023

Related U.S. Application Data
(60) Provisional application No. 63/405,554, filed on Sep. 12, 2022.

(51) Int. Cl. B23K 9/095; B23K 10/00; B25J 11/00

(52) U.S. Cl. CPC B23K 9/0953; B23K 10/00; B25J 11/005

(57) ABSTRACT

A highly mobile cart having an upper cantilevered selectively positionable extended support member for use with collaborative robot cutting and welding systems for deployment in manufacturing operations where the systems can be moved from one worksite to another without significant labor or rigging or substantial acquisition and installation capital expenditures, dedicated floor space, or ancillary internal support and operating systems.

### CROSS-REFERENCE TO RELATED APPLICATIONS

This application claims priority to U.S. Provisional Patent Application Ser. No. 63/405,554 filed on Sep. 12, 2022, the entire contents of which are incorporated herein by reference.

### FIELD OF THE INVENTION

The present invention relates generally to cutting and welding systems. More specifically, the present invention relates to mobile robot cutting and welding systems. In particular, the present invention relates to readily re-deployable collaborative robot cutting and welding systems and to mobile carts for use in such systems.

### BACKGROUND OF THE INVENTION

Welding engineering is a highly-specialized discipline which requires knowledge of not only structures, materials and manufacturing processes, but also knowledge of specific materials cutting and joining processes and parameters including weld joint configuration and preparation, cutting and welding process selection, preheat and post heat requirements as needed to prevent cracking, and other variables. A knowledgeable and experienced metal processing worker such as a machinist or a welder may assess the requirements of a particular job based upon prior experience and may adjust one or more of the foregoing parameters to achieve the desired edge configuration with the precision required for proper assembly and the welding parameters such as wire feed rate, welding voltage and current, weaving parameters, and travel speed. However, a less experienced individual may not be able to set up a cutting or welding job without performing trial and error runs on test pieces, a process which is time consuming, inefficient, and costly.

Automated robot and positioning systems controlled by computer software programs have displaced manual cutting, machining and welding fabrication operations in many industries. Analogous to CAD/CAM machine tool equipment, automatic robot cutting and welding systems are designed to minimize or completely eliminate the variables associated with manual operations, reduce the tedium associated with repetitive tasks, and enhance productivity and efficiency. In addition to the foregoing, typically, automated cutting and welding systems include a work holding table or positioner and a device such as an extendable boom or a robot arm which holds the cutting or welding implement such as an oxyacetylene or plasma torch, a stick or a continuous feed wire electrode. Either or both of these positioning and implement holding devices may be programmed to rotate about or translate along one or more axes to define a cutting path and may include multiple workstations which permit cutting of a first workpiece at one station while an operator removes a completed component and sets up a new work piece at a different station.

Depending upon the application, automated robot cutting and welding systems can be massive assemblies requiring substantial acquisition and installation capital expenditures, dedicated floor space, safety systems, utility inputs for electrical power, hydraulics and/or cooling water; and overhead cranes or lateral material conveyance systems for work material and finished assembly transport. Although such systems may be designed for smaller manufacturing operations and may be moved from one location to another via forklift and pickup truck, a typical cutting station or cell is not amenable for use with different cutting or welding systems, high mix, low volume production, or movement within a manufacturing facility without potentially disrupting other operations.

Materials processing operations such as machining, cutting and welding are so precise and the risks of property loss and/or personal injury to users of the end product structures and assemblies so pervasive in modern society are sufficiently high, that the setup and identification of the input variables in both manual and computer-controlled robot cutting operations, as well as the execution of the cutting process applicable to a given application, require manual input, a process that draws upon the skills and experience of the individual operator performing the task. However, a severe lack of skilled workers in today's workforce presents yet another challenge to meeting the demands of a highly consumptive economy. For example, in the cutting and welding field, the American Welding Society estimates the average age of a welder to be 54 years old. The number of active welders is decreasing at a rate that is significantly higher than the entry rate of new welders into the field, and a potential shortage of approximately 400,000 welders in the United States is projected to exist by 2025. The situation is further exacerbated by socio-economic societal changes brought about by the expectations and demands of younger generations for higher paying jobs in what are viewed as the “high tech” fields of computer science, programming, communications, information technology, and the like. Traditional jobs in manufacturing, agriculture, foundries and mining are now viewed as less desirable or have migrated off-shore.

Consequently, manufacturers are under tremendous stress to increase manufacturing productivity through automation but currently have only risky and costly options to do so. Traditional robotic system solutions are a significant financial risk, bulky and expensive, with long delivery times, significant set-up time and cost, and what operations managers view as “well, no-turning-back now” risk. While larger corporations may be able to bear the cost and risk of traditional automation, the smaller shops that make up 75% of America's 250,000+manufacturers are prohibited by the high capital investment requirements from availing themselves of the advantages offered by either partially or fully automated systems.

In view of the above, it is evident on the one hand that demands in the cutting and welding industry for reliable, consistent and repeatable materials processing and fabrication processes may be satisfied by sophisticated and very costly automated systems that minimize the potentially adverse and unpredictable effects of human and process variables on weld quality. However, conflicting demands for relatively inexpensive, mobile and versatile systems capable of producing end products and components therefor of the highest quality that may also be set up and operated by less experienced individuals in high mix, low volume production environments create a tension in the manufacturing industry that heretofore has not been addressed by prior art systems. Accordingly, it will be apparent to those skilled in the art from this disclosure that a need exists for collaborative robot materials processing systems such as cutting and welding systems that can be set up and programmed intuitively by an operator without the need for significant computer programming and coding training. A need also exists for a readily re-deployable and transportable automated cutting system that may be installed in a manufacturing operation and moved from one worksite to another without significant labor or rigging or substantial acquisition and installation capital expenditures, dedicated floor space, or ancillary internal support and operating systems The present invention addresses the aforementioned needs in the art as well as other needs, all of which will become apparent to those skilled in the art from the accompanying disclosure.

### SUMMARY OF THE INVENTION

In accordance with the embodiments of the present invention, a highly mobile cart for use with collaborative robot materials process systems such as cutting and welding systems is disclosed for use in manufacturing operations where the systems can be moved from one worksite to another without significant labor or rigging or substantial acquisition and installation capital expenditures, dedicated floor space, or ancillary internal support and operating systems.

In an embodiment, a highly mobile collaborative robot cutting system includes a highly mobile cart including a mobile base having a worksurface, the mobile cart being adapted to be relocated without significant labor and/or rigging to bring a cutting or a welding system to the work.

In still another embodiment, a highly mobile collaborative robot cutting or welding system includes a highly mobile cart having a mobile base including a work surface, a bottom or lower platform adapted to stow and transport system accessory equipment, an upper cantilevered extended support member operatively connected to the work surface, and a collaborative robot positioning arm operatively connected to the upper cantilevered extended support member, the mobile cart being adapted to be relocated without significant labor and/or rigging to bring the cutting or welding system to the work.

In another embodiment, a highly mobile collaborative robot cutting or welding system includes a highly mobile cart having an extended mobile base including a work surface, a bottom or lower platform adapted to stow and transport system accessory equipment, and an upper cantilevered extended support member operatively connected to the work surface, and a collaborative robot cutting or welding arm operatively connected to the upper cantilevered extended support member, the mobile cart and extended mobile base being adapted to be relocated without significant labor and/or rigging to bring the cutting or welding system to the work.

In an embodiment, the extended support member is a cantilevered beam.

In another embodiment, the collaborative robot cutting or welding system and mobile cart are adapted to be positioned adjacent separate preexisting fixtures within a reach distance of the programmable cutting arm, whereby cutting or welding operations are performed on materials on the adjacent separate fixtures.

In still another embodiment, a highly mobile collaborative robot cutting or welding system includes a highly mobile cart having an extended mobile base including a work surface, a bottom or lower platform adapted to stow and transport system accessory equipment, and an upper cantilevered arm or beam operatively connected to the work surface, and a collaborative robot cutting or welding arm operatively connected to the upper cantilevered arm or beam, wherein the cantilevered arm or beam is selectively rotatable about an axis to bring the cutting or welding system to the work without moving the mobile cart and base.

In another embodiment, the programmable collaborative robot arm includes a built-in safety in the robot arm itself.

In another embodiment, the collaborative robot cutting or welding system and highly mobile cart having a mobile base include a safety system which permits the collaborative cutting or welding system to be operated at a faster speed under predetermined conditions which are safe for an operator and which reduces the system operating speed in accordance with recognized safety standards in response to conditions detected by the safety system.

In still another embodiment, the collaborative robot cutting or welding system includes a corner-mounted operator protection safety system mounted on the cart's mobile base.

In yet another embodiment, the work surface is a gridded work surface.

In another embodiment, a collaborative robot cutting or welding system provides enhanced production efficiency by allowing an operator to set up and complete more tasks through parallel and simultaneously performed operational steps and by shifting repetitive, monotonous cutting tasks to the collaborative robot cutting system.

In an embodiment, a collaborative cutting or welding system includes highly mobile cart having a gridded worktable or work surface, the work table or work surface including a plurality of apertures formed therein, each of the apertures being adapted to releasably receive a clamp or other securement device for holding a workpiece, fixture, assembly or raw work material in a fixed position during the performance of a work material processing sequence.

In still another embodiment, a method for cutting materials using a collaborative robot cutting system is disclosed in accordance with the present invention.

These and other features, aspects and advantages of the present invention will become apparent to those skilled in the art from the following detailed description of preferred embodiments taken in connection with the accompanying drawings, which are summarized briefly below.

### BRIEF DESCRIPTION OF THE DRAWINGS

Referring now to the attached drawings which form a part of this original disclosure:

FIG. 1 is a left side perspective view of the elements of a highly mobile cart including a mobile base having a collaborative robot cutting system mounted thereon in accordance with an embodiment of the present invention;

FIG. 2 is a right side perspective view of the highly mobile cart and collaborative robot cutting system of FIG. 1;

FIG. 3 is a bottom front perspective view of the highly mobile cart and collaborative robot cutting system of FIG. 1;

FIG. 4 is a bottom rear perspective view of the highly mobile cart and collaborative robot cutting system of FIG. 1;

FIG. 5 is a front view of the highly mobile cart and collaborative robot cutting system of FIG. 1;

FIG. 6 is a left side view of the highly mobile cart and collaborative robot cutting system of FIG. 1;

FIG. 7 is a top view of a highly mobile cart and collaborative robot cutting system including a gridded work surface;

FIG. 8 is a lower left side perspective view of a highly mobile cart including a collaborative robot cutting system mounted thereon having a pin locking mechanism adapted to rotatably position a selectively positionable extended support member rotatably operatively connected to an upper surface thereof in accordance with an embodiment;

FIG. 9 is a front top side perspective view a highly mobile cart including a collaborative robot welding system mounted thereon having a retractable pin mechanism to lock the positionable extended support member in a selected rotational position enlarged to more clearly illustrate the features thereof;

FIG. 10 is an upper left side perspective view of a highly mobile cart including a collaborative robot welding system mounted thereon having a motorized rotation system adapted to rotatably position a selectively positionable extended support member rotatably operatively connected to an upper surface thereof in accordance with an embodiment;

FIG. 11 is a rear top perspective view of the highly mobile cart and welding system illustrated in FIG. 10;

FIG. 12 is a bottom front perspective view of the highly mobile cart and collaborative robot welding system illustrated in FIGS. 10 and 11;

FIG. 13 is a bottom rear perspective view of the highly mobile cart and collaborative robot welding system illustrated in FIGS. 10-12;

FIG. 14 is a front top side perspective view of the highly mobile cart and collaborative robot welding system of FIGS. 10-13 further including safety scanners for enabling the collaborative robot to move faster; and

FIG. 15 is a rear top side perspective view of a highly mobile cart and collaborative robot welding system having a motorized rotation system including a slew drive adapted to rotatably position a selectively positionable extended support member rotatably operatively connected to an upper surface thereof in accordance with an embodiment.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claim and its equivalents.

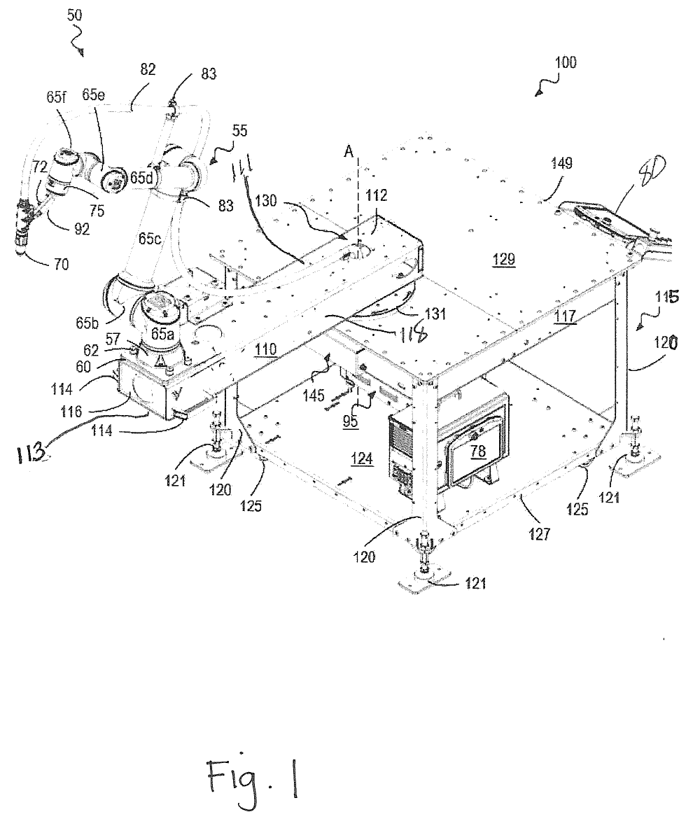

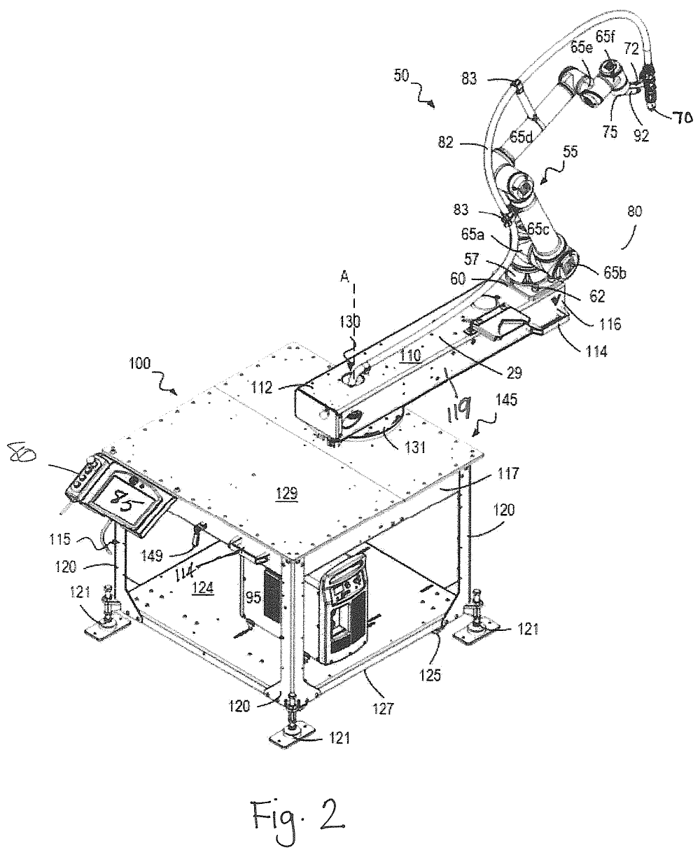

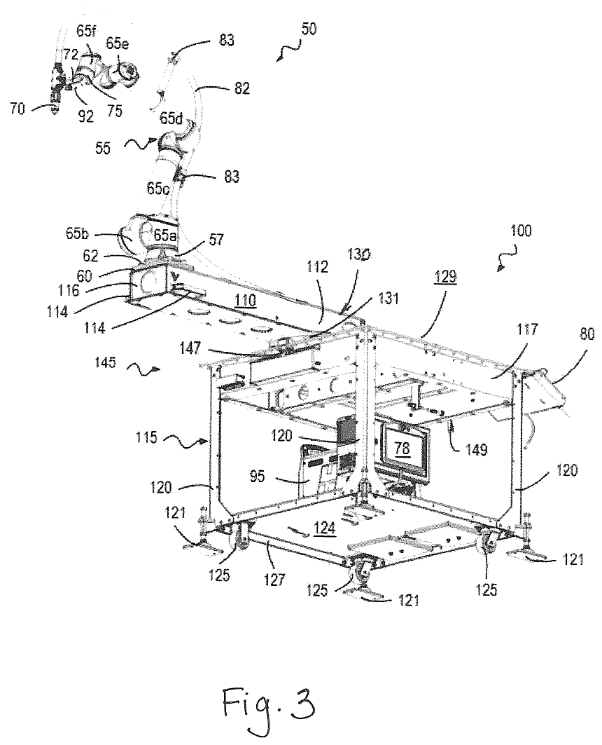

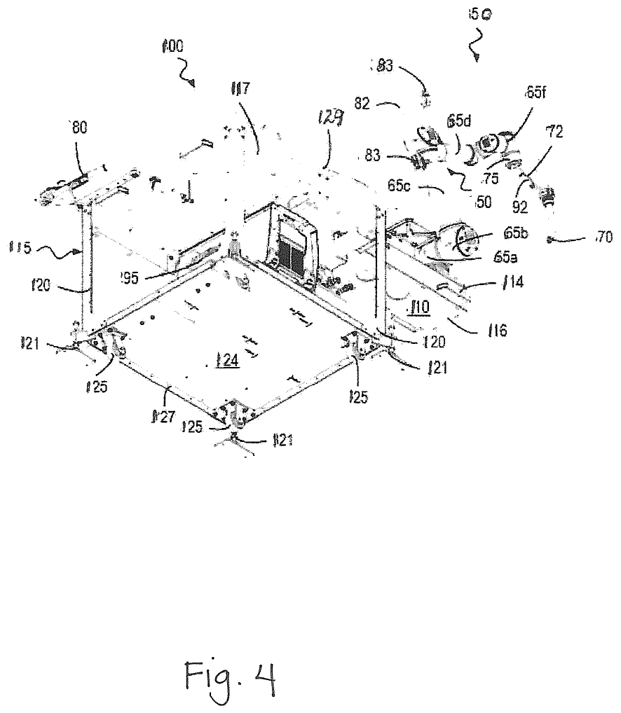

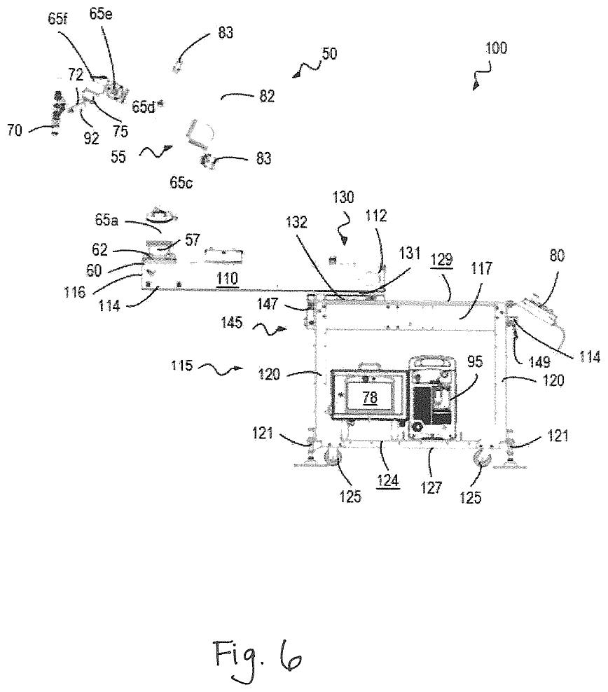

Referring now to FIGS. 1 through 6, the elements of a highly mobile cart 115 having a collaborative robot cutting system 100 mounted thereon and including a selectively positionable extended support member or cantilever beam 110 is illustrated in accordance with an embodiment. The extended support member is in the form of a selectively positionable cantilever beam 110 having a distal end 116 extending outwardly from the cart and a proximal end 112 rotatably operatively connected to an upper work surface or table 129 supported by a frame 117. By way of example and not of limitation, the cantilever beam is in the form of a welded box beam having top and bottom panels or surfaces 111, 113 and first and second side panels or surfaces 118, 119 and one or more handles 114 operatively connected to each of the side panels 118, 119 and extending outwardly therefrom. However, it is to be understood that extended support members having different configurations may be used without departing from the scope of the instant invention. The worktable is approximately six (6) feet wide and six (8) feet deep. The worktable or mobile cart further includes a plurality of supporting legs 120 operatively connected to the frame 117, each supporting leg including a levelling device or foot 121 attached thereto, a storage area or platform 124 having a plurality of wheels or casters 125 mounted to a bottom surface 127 thereof. One or more of the handles 114 are also mounted on the frame 117 to enable an operator to move and position the system 100 as needed for any specific application or job.

The cutting system 100 further includes a collaborative robot system 50 (known in the art as a cobot), such as a Universal Robots™ UR10e collaborative industrial robot. However, it is to be understood that collaborative robot systems either specifically designed and built for individual applications or other generally commercially available collaborative robot systems may also be used without departing from the scope of the present invention. The collaborative robot system comprises a robot arm 55 operatively connected to a base 57, which, in turn, is mounted on an electrically isolating pad 60 secured by suitable fasteners 62 to the top panel 111 of the cantilever beam 110. The robot arm includes a plurality of arm segments 65a-65f sequentially pivotally and/or rotatably interconnected to one another and structured and arranged to have a reach length or distance which depends upon the size of the robot arm selected for use in the collaborative robot system 50 and the lengths of its individual segments. A built-in safety feature (not shown) in the robot arm is structured and arranged to interrupt movement of the arm, should it come in contact with the operator or another object. A cutting implement or torch 70 is secured via an attachment 72 to a distal end 75 of the robot arm, the implement being universally positionable and translatable along a preselected path in response to instructions from a robot controller 78, teach pendant 80 and application programming interface (API) display 85. In the embodiment of FIGS. 1-6, by way of example and not of limitation, the implement 70 is depicted in the form of a cutting torch representative of the type used in plasma cutting processes; however, it is to be understood that the system of the present invention may be used with any cutting process without departing from the scope of the present invention. The members of the collaborative robot system 50 are covered by a protective material or shield wrap (not shown) to protect the elements thereof from spatter generated by cutting operations.

A programming or hand-guided jog button 92 is secured to the attachment 72 and is operatively connected to the robot controller 78 and teach pendant 80 and, as will be described in greater detail below, is adapted to allow an operator to set up and program the cutting system in an intuitive and graphical manner. Cutting and shielding gas is delivered from a central gas supply system or from individual gas cylinders via the torch bundle 82 to the cutting nozzle 70, as is known in the art, where the torch bundle is secured to the robot arm by bundle management brackets 83. Power is provided to the cutting implement via power supply 95, and the power supply, robot controller, teach pendant, cutting torch, and any ancillary power tools an operator may need all may be operatively connected to single phase power, for example, 120V power for the collaborative robot system and 240V power for the power supply. Optionally, the power supply may be connected to 208V, 480V or 575V three phase power.

The availability of conventional shop power combined with the portability of the highly mobile cart 115 and worktable contribute to the overall flexibility and adaptability of the cutting system. It can be brought to the location of the work material and set up anywhere in a shop or in the field quickly with little lead time. The cutting system in the embodiment of FIGS. 1-6 mounted on the worktable occupies a small area having a full system footprint of approximately three (3) feet wide and six (6) feet deep, and does not require a large investment in utilities, dedicated factory space, safety guards and materials handling equipment. The cutting system is particularly adaptable for high mix, low production small or medium-sized piece parts such as brackets, angles, handles, and the like.

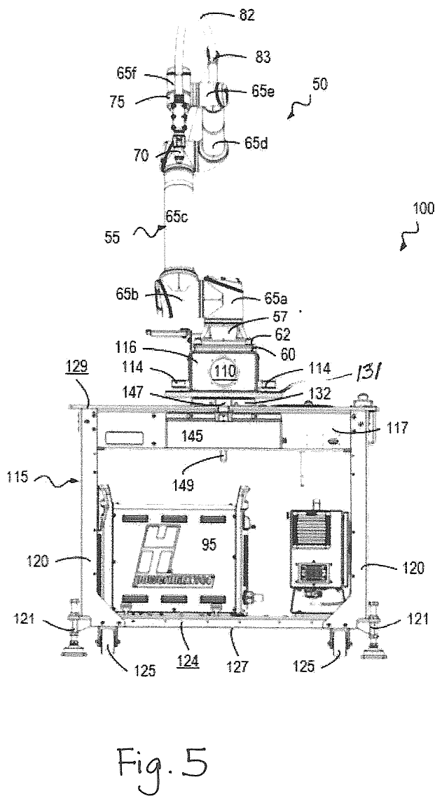

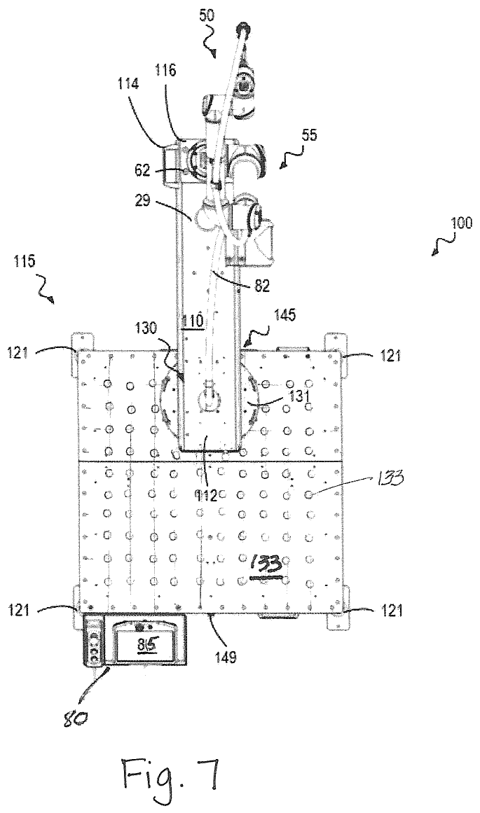

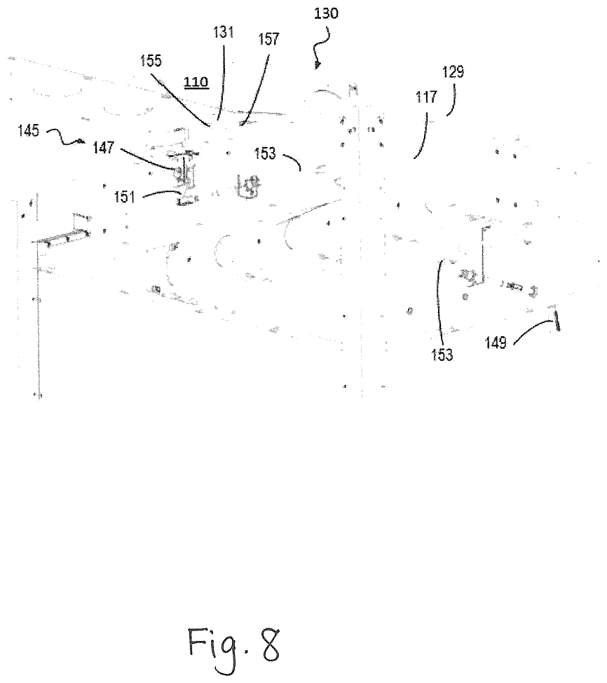

The collaborative robot cutting system 100 is designed to process larger work materials and parts by augmenting the reach of the cobot 50 by mounting it on the top panel or surface 111 at the distal end 116 of the cantilever beam 110. The augmented reach of the system is further enhanced via a cantilever beam mounting or connecting mechanism shown generally at 130 which is adapted to permit selective rotatable positioning of the cantilever beam and cobot cutting system about axis A-A over extended radial points above large work material or structures. Shown in greater detail in FIGS. 5-8, in the embodiment shown, the mounting or connecting mechanism is in the form of a pivot connection which includes a mounting plate 131 secured to the proximal end 112 of the cantilever beam and rotatably secured to a bearing shaft or post 132 operatively connected to the upper work surface or table 129. To achieve consistency and repeatability in positioning the cobot, a retractable pin mechanism 145 including a pin 147, a directionally changing linkage 151, push-pull cable 153, and actuating handle 149 which is urged by a suitable biasing mechanism, by way of example and not of limitation a spring or a hydraulically actuated piston, into releasable locking engagement with a preselected one of a plurality of apertures 157 positioned at spaced-apart radial locations on a bottom surface 155 of the mounting plate 131 (FIG. 8). In an embodiment, a collaborative cutting or welding system includes highly mobile cart having a gridded worktable adapted to receive and secure work material and work holding fixtures thereto, as shown at 133 in FIG. 7.

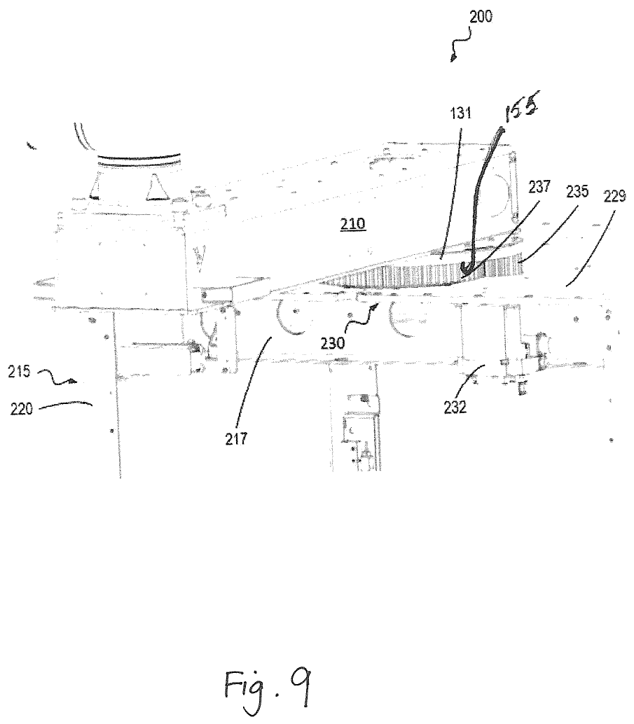

Referring now to FIG. 9, portions of a highly mobile cart system 200 having a selectively positionable extended support member or cantilever beam 210 adapted for use with a collaborative robot cutting or welding system in accordance with another embodiment of the present invention are shown. Of similar configuration to that of the embodiment 100 of FIGS. 1 through 6, the system 200 includes a mobile cart 215 having a frame 217, a plurality of supporting legs 220, and an upper work surface or table 229. In contrast to the selective rotatable positioning of the cantilever beam 110 in the embodiment of FIGS. 1 through 6 which is performed manually by an operator, the cantilever beam 210 in the embodiment of FIG. 9 is selectively positioned by a slewing ring-pinion gear mechanism 230 activated by a servo motor 232 mounted on the frame 217. A pinion gear 235 is operatively connected to the servo motor and adapted to rotatably engage a slewing ring 237 secured to the bottom surface 155 of a mounting plate 131. The servo motor may be selectively activated to rotate in either direction, thus rotatably urging the cantilever beam and cobot cutting system to a desired radial position in response to rotational forces exerted on the slewing ring by the pinion gear.

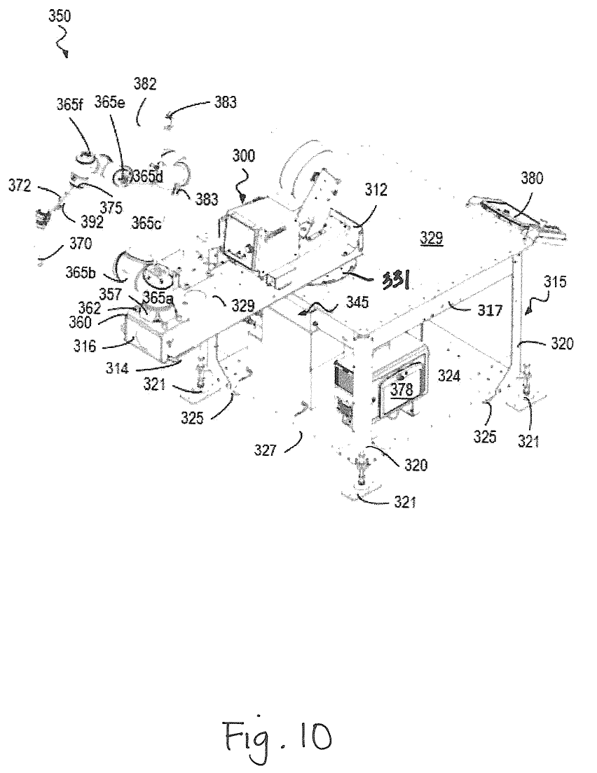

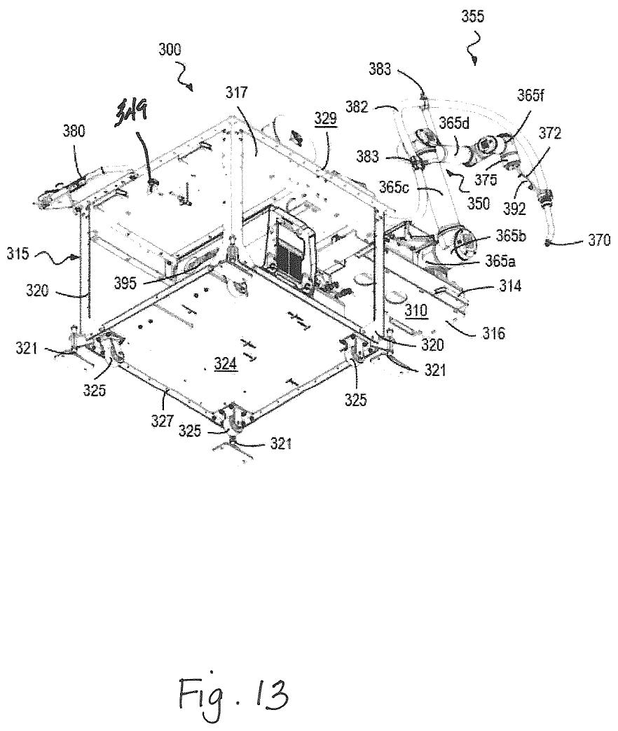

Referring now to FIGS. 10 through 13, in accordance with another embodiment, the elements of a highly mobile cart 315 having collaborative robot welding system 300 and cobot 350 mounted on a selectively positionable extended support member or cantilever beam 310 are illustrated. Similar in construction to the embodiment of FIGS. 1-6, the extended support member is in the form of a selectively positionable cantilever beam 310 having a proximal end 312 and a distal end 316, the proximal end being rotatably operatively connected to an upper work surface or table 329 mounted on a frame 317. The mobile cart includes an extended worktable having an extended size of approximately six (6) feet wide and six (8) feet deep. The mobile cart includes the frame 317, a plurality of supporting legs 320, each including a levelling device or foot 321 attached thereto, a storage area or platform 324 having wheels or casters 325 mounted to a bottom surface 327 thereof.

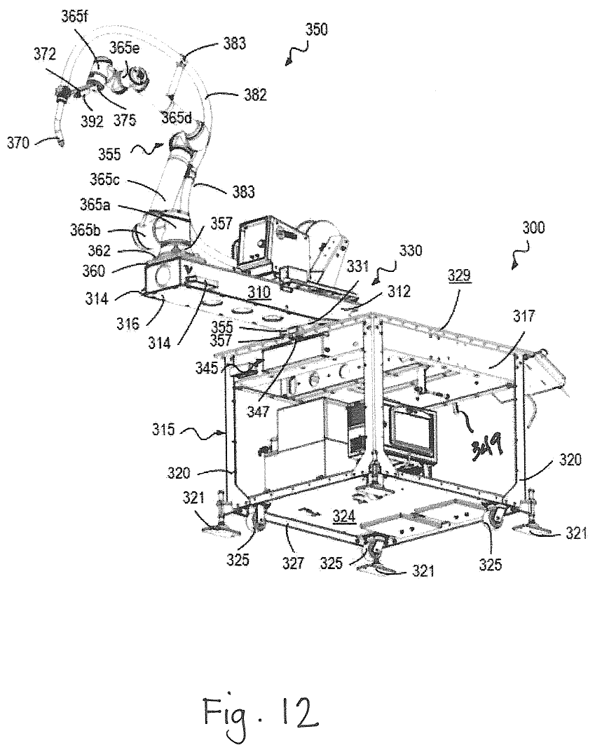

The collaborative robot welding system 300 is designed to process larger work materials and parts by augmenting the reach of the cobot 350 by mounting it on the distal end 316 of the cantilever beam 310. The augmented reach of the system is further enhanced via a pivot connection or mount shown generally at 330 which is adapted to permit selective rotatable positioning of the cantilever beam and cobot welding system about axis A-A over extended radial points above large work material or structures. The pivot connection includes a mounting plate 331 secured to the proximal end of the cantilever beam and rotatably secured to a bearing shaft or post (not shown) operatively connected to the upper work surface or table 329. To achieve consistency and repeatability in positioning the cobot, a retractable pin mechanism 345 including a pin 347 and actuating handle 349 which is urged by a suitable biasing mechanism, by way of example and not of limitation a spring or a hydraulically actuated piston, into releasable locking engagement with a preselected one of a plurality of apertures 357 positioned at spaced-apart radial locations on a bottom surface 355 of the mounting plate 331 (FIG. 12).

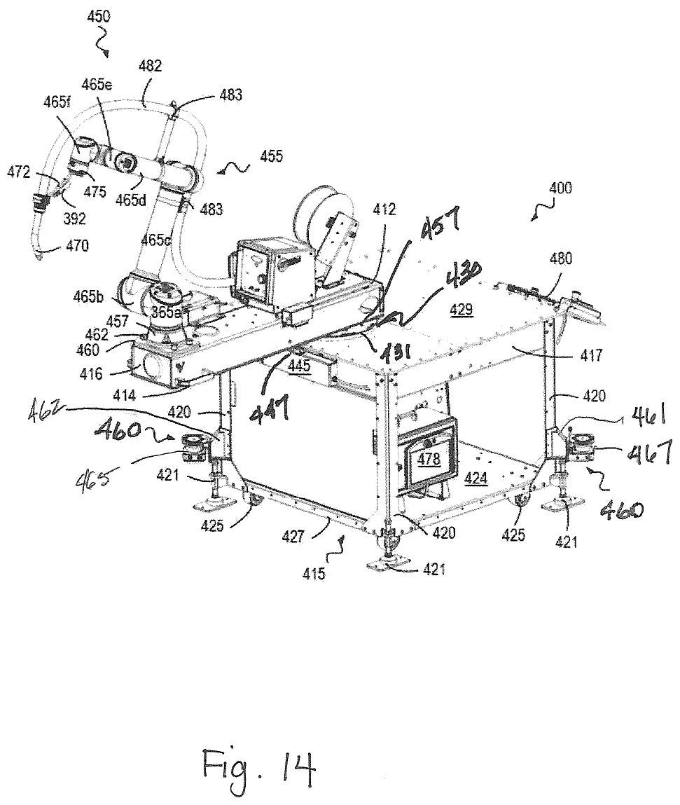

Referring now to FIG. 14, the elements of a highly mobile cart 415 having collaborative robot welding system 400 and cobot 450 mounted thereon and including a selectively positionable extended support member or cantilever beam 410 with safety scanners 460 mounted to frame 417 is illustrated in accordance with an embodiment. Similar in construction to the embodiment of FIGS. 1-6, the extended support member is in the form of a selectively positionable cantilever beam 410 having a proximal end 412 and a distal end 416, the proximal end being rotatably operatively connected to an upper work surface or table 429. The mobile cart includes an extended worktable having an extended size of approximately six (6) feet wide and six (8) feet deep. The mobile cart includes a frame 417, a plurality of supporting legs 420, each including a levelling device or foot 421 attached thereto, a storage area or platform 424 having wheels or casters 425 mounted to a bottom surface 427 thereof.

As will be described in greater detail below, the welding system 400 system further includes a corner-mounted operator protection safety system shown generally at 460 which detects the presence of an operator, other personnel or a vehicle such as a forklift in preselected safety zones or non-visible safety barriers. It is referred to hereinafter as “the LIDAR safety system” or alternatively, “the safety system”, as appropriate in the context. The LIDAR safety system is adjustably and rotatably secured to the bottom end portions of diagonally opposed legs 420 of the cart frame 417 by brackets 461 and 462. The operating and control components of the system are contained within cylindrical housing 465, 467 respectively, which are adjustably positionable to control the radii and corresponding circumference ranges of safety zones generated by the LIDAR safety system scan, respectively (not shown). LIDAR is an acronym for light detection and ranging or, alternatively, laser imaging, detection, and ranging, a system which uses ultraviolet (UV), visible or near infrared (NIR) light to detect objects and to determine ranges or distances from the emitter/detector to the object. The LIDAR system of the corner-mounted operator protection safety system 460 of the collaborative robot welding system of the instant invention is used to detect the presence of an operator, other personnel or a vehicle such as a forklift in preselected safety zones or non-visible safety barriers surrounding the collaborative robot welding system 400. These safety zones or barriers are generated by the LIDAR scan projected out by the system. When any object is detected in one of the zones, the operating speed of the robot system is reduced for safety purposes or the robot system is stopped if used with the motorized rotation system. Coupled with the built-in safety system of the robot arm, which stops its movement when the arm contacts an object, the system possesses dual chain safety feature redundancy. This feature also enhances production rates, inasmuch as the system may be operated confidently at higher speeds under normal conditions knowing that if an unsafe condition is detected, the system will respond proactively to protect the operator and other personnel in the area.

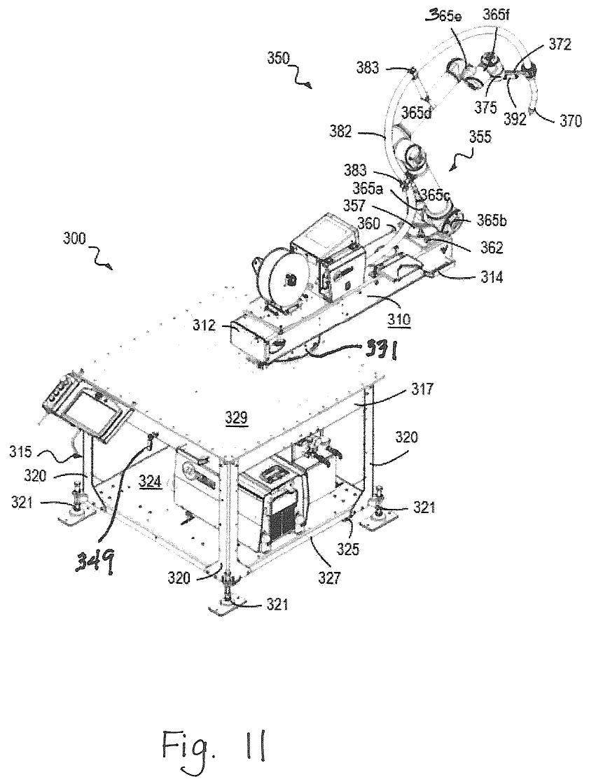

The collaborative robot welding system 400 is designed to process larger work materials and parts by augmenting the reach of the cobot 450 by mounting it on the distal end 416 of the cantilever beam 410. The augmented reach of the system is further enhanced via a pivot connection or mount shown generally at 430 which is adapted to permit selective rotatable positioning of the cantilever beam and cobot welding system about axis A-A over extended radial points above large work material or structures. The pivot connection includes a mounting plate 431 secured to the proximal end of the cantilever beam and rotatably secured to a bearing shaft or post (not shown) operatively connected to the upper work surface or table 429 in the same manner as herein described with respect to the embodiment of FIGS. 11 and 12. To achieve consistency and repeatability in positioning the cobot, a retractable pin mechanism 445 including a pin 447 and actuating handle which is urged by a suitable biasing mechanism, by way of example and not of limitation a spring or a hydraulically actuated piston, into releasable locking engagement with a preselected one of a plurality of apertures 457 positioned at spaced-apart radial locations and extending through the mounting plate 431.

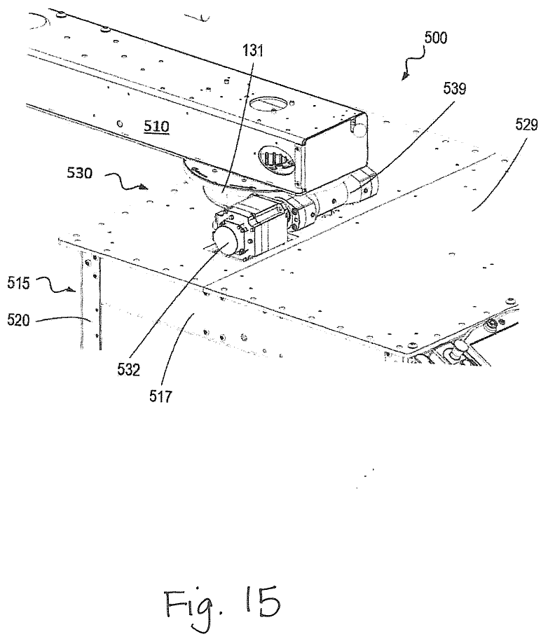

Referring now to FIGS. 15, portions of a highly mobile cart system 500 adapted for use with a collaborative robot cutting or welding system are shown. The cart system including a selectively positionable extended support member 510 is illustrated in accordance with the embodiments of the present invention described above. Of similar configuration to that of the embodiment 100 of FIGS. 1 through 6, the system 500 includes a mobile cart 515 including a frame 517, a plurality of supporting legs 520, and an upper work surface or table 529 operatively connected thereto. In contrast to the selectively rotatable positioning of the cantilever beam 110 in the embodiment of FIGS. 1 through 6 which is performed manually by an operator, the cantilever beam in the embodiment of FIG. 15 is selectively positioned by a slewing drive having a slewing ring and worm gear mechanism 539 activated by a servo motor 532 mounted on work surface or table 529. The worm gear rotatably engages a slewing ring 237 secured to the bottom surface 155 of a mounting plate 131 as discussed above and shown in FIGS. 10 and 12. The servo motor may be selectively activated to rotate in either direction, thus rotatably urging the cantilever beam and cobot cutting system to a desired radial position in response to rotational forces exerted on the slewing ring by the pinion gear.

In operation, by way of example and not of limitation, the collaborative robot cutting and welding systems of the present invention may be used to cut intricate shapes and patterns into work materials, and, with respect to the welding system, to make difficult weldments on irregularly shaped and complex assemblies that may not be feasible to make on prior art systems. By way of example in an exemplary cutting application, the operator brings the work materials to be cut to the collaborative robot such as where the system 100 of FIG. 1 is advantageously employed for cutting large assemblies. Alternatively, the operator brings the collaborative robot to the work material, as for example, in the situation where cutting must be performed in the field by manually moving the collaborative cutting system to the material to be processed, moves the cantilever beam and cobot cutting system either manually or by using the slewing ring-pinion gear mechanism 230, or worm gear mechanism 539 depending on the embodiment of the system to a desired radial position and powers on the cutting power supply and the collaborative robot. The work material is aligned in accordance with the prescribed cut specifications set forth in the associated design drawings and specifications and may be tacked, held in a fixture, or otherwise secured in position. At this point and at any point in the setup and cutting process, the operator may select a hand-guided jogging mode by depressing the programming or hand-guided jog button 92 on the handle of the cutting torch bracket 72. This mode permits free movement and positioning of the robot arm 55 and the torch 70 by the operator. The operator may conveniently engage and disengage the hand-guided jogging mode as needed at any time during the performance of a cut setup and execution procedure. Once the work materials and the robot arm are located relative to one another, the operator may commence the program setup by using the programming button 92 in conjunction with the teach pendant 80 to create a cut path. The programming includes the steps of performing a clearance move of the cutting torch in a hand-guided jogging mode to permit an operator to manually move the cutting arm; performing a clearance move of the cutting arm to create a home or approach position to the cut path; creating waypoints along the cut path by moving the cutting arm manually; saving the waypoints in the program; creating a cut end point; creating a depart point; and ending the program upon completion of the cut. While the foregoing process steps have been illustrated with respect to performing a cut, it is to be understood that an analogous procedure may be used with a highly mobile collaborative robot welding system such as described in FIG. 10 without departing from the scope of the present invention.

While only selected embodiments have been chosen to illustrate the present invention, it will be apparent to those skilled in the art from this disclosure that various changes and modifications can be made herein without departing from the scope of the invention as defined in the appended claim. Furthermore, the foregoing descriptions of the embodiments according to the present invention are provided for illustration only, and not for the purpose of limiting the invention as defined by the appended claim and its equivalents.

What is claimed is:

1. A mobile material processing system for performing processing operations on raw work material, comprising:
a mobile base;
an extended selectively positionable cantilevered support member operatively connected to the mobile base;
a material processing implement;
at least one programmable collaborative robot operatively connected to the extended cantilevered support member and adapted to hold and manipulate the material processing implement;
a power supply operatively connected to the material processing implement;
a control system adapted to enable an operator to guide the robot and manipulate the material processing implement to operatively engage and process the work material in response to instructions programmed by the operator.

2. The mobile material processing system of claim 1 wherein the mobile base comprises a mobile cart adapted to be relocated by an operator to bring the mobile material processing system to the work material.

3. The mobile material processing system of claim 1 wherein the mobile base includes an upper work surface or table supported by a frame, a plurality of supporting legs operatively connected to the frame, a bottom or lower platform adapted to stow and transport system accessory equipment.

4. The material processing system of claim 3 wherein the bottom or lower platform includes a bottom surface and a plurality of wheels or casters 125 operatively connected to the bottom surface.

5. The material processing system of claim 3 wherein each one of the plurality of supporting legs includes a levelling device or foot operatively connected thereto.

6. The material processing system of claim 3 wherein the upper work surface or table includes a gridded work surface adapted to receive and secure work material and work holding fixtures thereto.

7. The material processing system of claim 6 wherein the gridded work surface includes a plurality of apertures formed therein, each of the apertures being adapted to releasably receive a clamp or other securement device for holding a workpiece, fixture, assembly or raw work material in a fixed position during the performance of a work material processing sequence.

8. The material processing system of claim 1 wherein the at least one programmable collaborative robot includes a programmable robot arm having a built-in safety mechanism.

9. The material processing system of claim 8 wherein the mobile base includes a safety system which permits the collaborative welding system to be operated at a faster speed under predetermined conditions which are safe for an operator and which reduces the system operating speed in accordance with recognized safety standards in response to conditions detected by the safety system.

10. The material processing system of claim 1 wherein the at least one collaborative robot comprises a programmable robot arm, a base operatively connected to the robot arm and adapted to mount the robot arm to the extended cantilevered support member, and an electrically isolating pad positioned intermediate the base and the extended cantilevered support member.

11. The material processing system of claim 10 wherein programmable robot arm includes a built-in safety mechanism.

12. The material processing system of claim 1 wherein the material processing implement comprises a welding torch.

13. The material processing system of claim 1 wherein the material processing implement comprises a plasma cutting torch.

14. The material processing system of claim 1 further including a mounting or connecting mechanism adapted to operatively connect the extended selectively positionable cantilevered support member to the mobile base.

15. The material processing system of claim 14 wherein the mounting or connecting mechanism comprises a pivot connection including a mounting plate secured to a proximal end of the cantilever beam, the mounting plate further being rotatably secured to a bearing shaft or post operatively connected to the mobile base.

16. The material processing system of claim 14 wherein the mounting or connecting mechanism comprises a mounting plate secured to a proximal end of the cantilever beam, a slewing ring operatively connected to a bottom surface of the mounting plate, a servo motor mounted on the mobile base, and a pinion gear operatively connected to the servo motor and adapted to rotatably engage the slewing ring.

17. The material processing system of claim 14 wherein the mounting or connecting mechanism comprises a rotatably engaged slewing ring and worm gear mechanism, the slewing ring being operatively connected to a bottom surface of mounting plate secured to a proximal end of the cantilever beam, and a worm gear and a servo motor operatively connected to the mobile base.

18. A method for performing processing operations on raw work material using a collaborative robot welding system, the welding system including a mobile base, an extended selectively positionable cantilevered support member operatively connected to the mobile base, a welding system and a collaborative robot operatively connected to the extended selectively positionable cantilevered support member, and a welding power supply, the method comprising the steps of:
a. moving the collaborative welding system to material to be fabricated;
b. moving the cantilevered support member and cobot welding system either manually or by using a slewing ring-pinion gear mechanism, or a worm gear mechanism to a desired radial position;
c. powering on the welding power supply and the collaborative robot;
d. aligning the material to be fabricated in accordance with a prescribed joint configuration set forth in associated design drawings and specifications;
e. manually moving and positioning a welding arm and a welding torch operatively connected to the collaborative robot to the material to be fabricated;
f. programming the collaborative robot program to create a welding path; and
g. executing the program to fabricate the weldment.

19. The method of claim 18 wherein the step of programming the weld path further includes the steps of:
h. selecting a hand-guided jogging mode to permit an operator to manually move the welding arm;
i. performing a clearance move of the welding arm to create a home or approach position to the weld path;
j. creating waypoints along the weld path by moving the welding arm manually;
k. saving the waypoints in the program;
I. creating a weld end point;
m. creating a depart point; and
n. ending the program upon completion of the weldment fabrication.

20. A method for performing processing operations on raw work material using a collaborative robot cutting system, the cutting system including a mobile base, an extended selectively positionable cantilevered support member operatively connected to the mobile base, a cutting system and a collaborative robot operatively connected to the extended selectively positionable cantilevered support member, and a cutting power supply, the method comprising the steps of:
a. moving the collaborative cutting system to material to be fabricated;
b. moving the cantilevered support member and cobot cutting system either manually or by using a slewing ring-pinion gear mechanism, or a worm gear mechanism to a desired radial position;
c. powering on the cutting power supply and the collaborative robot;
d. aligning the material to be fabricated in accordance with a prescribed joint configuration set forth in associated design drawings and specifications;
e. manually moving and positioning a cutting arm and a cutting torch operatively connected to the collaborative robot to the material to be fabricated;
f. programming the collaborative robot program to create a cutting path; and
g. executing the program to fabricate the cut.

21. The method of claim 20 wherein the step of programming the cutting path further includes the steps of:
h. selecting a hand-guided jogging mode to permit an operator to manually move the cutting arm;
i. performing a clearance move of the cutting arm to create a home or approach position to the cutting path;
j. creating waypoints along the cutting path by moving the welding arm manually;
k. saving the waypoints in the program;
I. creating a cut end point;
m. creating a depart point; and
n. ending the program upon completion of the cut.
